(19) United States
(12) Patent Application Publication
(10) Pub. No.: US 2016/0071176 A1
(43) Pub. Date: Mar. 10, 2016

(54) SELLING APPARATUS, SELLING METHOD, PROGRAM, AND RECORDING MEDIUM

(71) Applicant: RAKUTEN, INC., Tokyo (JP)

(72) Inventor: Kenta SAKAE, Shinagawa-ku (JP)

(73) Assignee: RAKUTEN, INC., Tokyo (JP)

(21) Appl. No.: 14/780,633

(22) PCT Filed: Jan. 30, 2014
(86) PCT No.: PCT/JP2014/052062

§ 371 Date: Sep. 28, 2015

(51) Int. Cl. G06Q 30/06

(52) U.S. Cl. CPC G06Q 30/0609

(57) ABSTRACT

A presenter (102) presents a sales page having disposed therein a current sales price of a commercial item having the sales price decreasing over time, a purchase object, and a reservation object. A purchase acceptor (103) accepts a purchase at the disposed sales price of the commercial item when the purchase object disposed in the sales page is selected. A reservation acceptor (104) accepts a purchase reservation at a non-public reserve price that is lower than the disposed sales price of the commercial item when the reservation object disposed in the sales page is selected. The presenter (102) further disposes, in the sales page, reservation information indicating a presence or absence of an accepted reservation.

### TECHNICAL FIELD

The present disclosure relates to a selling apparatus, a selling method, a program, and a non-transitory recording medium for selling a commercial item having a sales price decreasing over time.

### BACKGROUND ART

Conventionally, systems for running Internet-based auctions have been known. Among those Internet-based auctions, an auction system so-called a Dutch auction in which bids are received to purchase a commercial item at a presented price, while updating the presented price to drop gradually has been known (see, for example, Patent Literature 1).

### CITATION LIST

### Patent Literature

Patent Literature 1: Unexamined Japanese Patent Application Kokai Publication No. 2011-175636

### SUMMARY OF INVENTION

### Technical Problem

In selling systems for selling a commercial item having a price decreasing over time like the Dutch auction, prospective buyers who desire to purchase at a price as low as possible tend to purchase at a later time. Conversely, sellers desire to sell the commercial item at the price as high as possible in an early stage.

The present disclosure has been made in view of the aforementioned circumstances, and an objective of the present disclosure is to provide a selling apparatus, a selling method, a program, and a non-transitory recording medium capable of prompting a user to purchase a commercial item at a high price in an early stage.

### Solution to Problem

To accomplish the above objective, a selling apparatus according to a first aspect of the present disclosure includes: a presenter that presents a sales page having disposed therein a current sales price of a commercial item having a sales price decreasing over time, a purchase object, and a reservation object; a purchase acceptor that accepts a purchase at the disposed sales price of the commercial item when the disposed purchase object is selected; and a reservation acceptor that accepts a purchase reservation at a non-public reserve price that is lower than the disposed sales price of the commercial item when the disposed reservation object is selected, in which the presenter further disposes, in the sales page, reservation information indicating a presence or absence of an accepted reservation.

In the selling apparatus of the aforementioned aspect, the reservation information may include the number of the accepted reservations.

In the selling apparatus of the aforementioned aspect, in the reservation, the non-public reserve price is specified by specifying a non-public time period for purchasing the commercial item.

In the selling apparatus of the aforementioned aspect, when the reservation acceptor accepts a plurality of reservations at the same reserve price, and the sales price of the commercial item reaches the same reserve price, one of the plurality of reservations is selected, and a purchase process for a user who has made the selected reservation is executed.

In the selling apparatus of the aforementioned aspect, a reduction level of the sales price or a time period for price reduction is defined for each user who makes the reservation based on a ranking of the user who makes the reservation.

In the selling apparatus of the aforementioned aspect, the higher the raking of the user who makes the reservation is, the higher the reduction level of the sales price is or the shorter the time period for price reduction is.

A selling method according to a second aspect of the present disclosure is to be executed by a selling apparatus that includes a presenter, a purchase acceptor, and a reservation acceptor, and the method includes: a presenting step of causing the presenter to present a sales page having disposed therein a current sales price of a commercial item having a sales price decreasing over time, a purchase object, and a reservation object; a purchase accepting step of causing the purchase acceptor to accept a purchase at the disposed sales price of the commercial item when the disposed purchase object is selected; and a reservation accepting step of causing the reservation acceptor to accept a purchase reservation at a non-public reserve price that is lower than the disposed sales price of the commercial item when the disposed reservation object is selected, in which the presenting step, the presenter further disposes, in the sales page, reservation information indicating a presence or absence of an accepted reservation.

A program according to a third aspect of the present disclosure causes a computer to function as: a presenter that presents a sales page having disposed therein a current sales price of a commercial item having a sales price decreasing over time, a purchase object, and a reservation object; a purchase acceptor that accepts a purchase at the disposed sales price of the commercial item when the disposed purchase object is selected; and a reservation acceptor that accepts a purchase reservation at a non-public reserve price that is lower than the disposed sales price of the commercial item when the disposed reservation object is selected, in which the presenter further disposes, in the sales page, reservation information indicating a presence or absence of an accepted reservation.

A computer-readable non-transitory recording medium according to a fourth aspect of the present disclosure has stored therein a program that causes a computer to function as: a presenter that presents a sales page having disposed therein a current sales price of a commercial item having a sales price decreasing over time, a purchase object, and a reservation object; a purchase acceptor that accepts a purchase at the disposed sales price of the commercial item when the disposed purchase object is selected; and a reservation acceptor that accepts a purchase reservation at a non-public reserve price that is lower than the disposed sales price of the commercial item when the disposed reservation object is selected, in which the presenter further disposes, in the sales page, reservation information indicating a presence or absence of an accepted reservation.

### Advantageous Effects of Invention

According to the present disclosure, it is capable of prompting a user to purchase a commercial item at a high price during an early stage.

### BRIEF DESCRIPTION OF DRAWINGS

FIG. 1 is a diagram illustrating a configuration of a selling system according to a first embodiment;

FIG. 2 is a schematic block diagram illustrating a hardware configuration of a selling apparatus of the first embodiment;

FIG. 3 is a schematic block diagram illustrating a functional configuration of the selling apparatus of the first embodiment;

FIG. 4 is a diagram illustrating example data stored in a commercial item database;

FIG. 5 is a diagram illustrating an example change in the sales price of a commercial item of the first embodiment over time;

FIG. 6 is a diagram illustrating an example sales page;

FIG. 7 is a diagram illustrating an example reservation page;

FIG. 8 is a diagram illustrating example data stored in a reservation database of the first embodiment;

FIG. 9 illustrates an example flowchart of a sales process;

FIG. 10 illustrates an example flowchart of an initial process;

FIG. 11 illustrates an example flowchart of a reservation accepting process;

FIG. 12 illustrates an example flowchart of a price reducing process;

FIG. 13 is a schematic block diagram illustrating a functional configuration of a selling apparatus according to a second embodiment;

FIG. 14 is a diagram illustrating example data stored in a user database of the second embodiment;

FIG. 15 is a diagram illustrating example data stored in a reservation database of the second embodiment;

FIG. 16 is a diagram illustrating an example change in a sales price of a commercial item of the second embodiment over time;

FIG. 17 is a diagram illustrating example data stored in a reservation database according to a third embodiment; and

FIG. 18 is a diagram illustrating an example change in a sales price of a commercial item of the third embodiment over time.

### DESCRIPTION OF EMBODIMENTS

Embodiments of the present disclosure will now be described in detail with reference to figures.

### First Embodiment

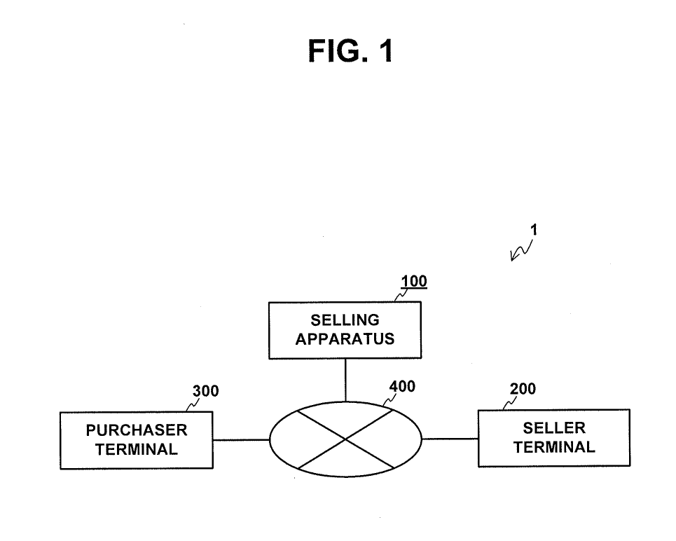

FIG. 1 illustrates a configuration of a selling system 1 according to an embodiment of the present disclosure. The selling system 1 is a system that manages sales/purchase of a commercial item through online. Note that according to the selling system 1 of this embodiment, the sales price of a commercial item decreases step by step over time. When accepting, from a user, a purchase at a currently offered sales price, the selling system 1 sells the commercial item to the user at this sales price. When accepting a purchase reservation at a reserve price lower than the currently offered sales price, the selling system 1 sells the commercial item to a user who has made the reservation at the reserve price when the current sales price reaches the reserve price.

As shown in FIG. 1, the selling system 1 includes a selling apparatus 100, a seller terminal 200, and a purchaser terminal 300, and the respective apparatuses are communicably connected one another via a network 400 such as the Internet.

The selling apparatus 100 is a server that manages the selling system 1 of this embodiment. More specifically, in response to requests from the seller terminal 200 and the purchaser terminal 300, the selling apparatus 100 provides various web pages of shopping sites managed by the selling system 1, registers a commercial item that will be on sale, searches a commercial item that is on sale, receives purchase/reservation of a commercial item, and executes a commercial item purchase process.

In the selling system 1 of this embodiment, the seller terminal 200 is a computer operated by a seller who sells a commercial item. More specifically, the seller terminal 200 transmits, to the selling apparatus 100, information on a commercial item that is input by the user who is the seller. Note that in FIG. 1, only a single seller terminal 200 is illustrated, but the number of the seller terminals 200 is not limited to this number.

In the selling system 1 of this embodiment, the purchaser terminal 300 is a computer operated by a purchaser who will purchase the commercial item. More specifically, the purchaser terminal 300, in response to an input operation by the user who is the purchaser, accesses to the selling apparatus 100, and browses, searches, reserves, and purchases the commercial item that is on sale. Although FIG. 1 illustrates a single purchaser terminal 300, the number of purchaser terminals 300 is not limited to this number.

Next, a configuration of the selling apparatus 100 will be described in detail.

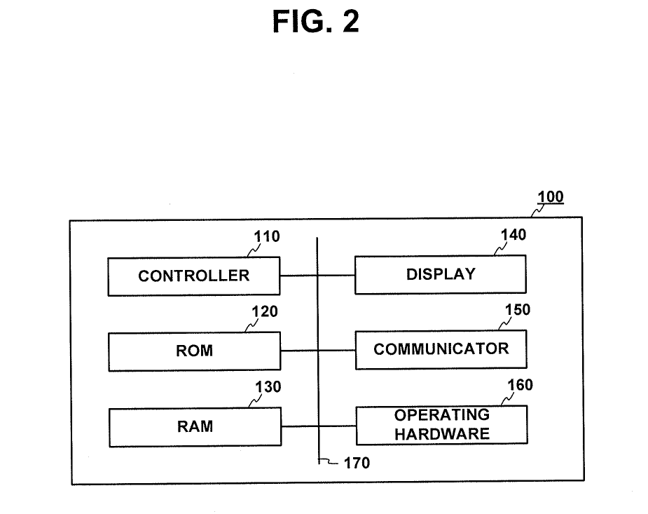

FIG. 2 is a schematic block diagram illustrating a hardware configuration of the selling apparatus 100. As illustrated in FIG. 2, the selling apparatus 100 includes a controller 110, a Read Only Memory (ROM) 120, Random Access Memory (RAM) 130, a display 140, a communicator 150, and an operating hardware 160, and the respective components are connected to one another via a bus 170.

The controller 110 includes, for example, a Central Processing Unit (CPU) which controls the selling apparatus 100 entirely.

The ROM 120 is a non-volatile memory for storing a program and various data for the controller 110 to control the entire selling apparatus 100.

The RAM 130 is a volatile memory for temporarily storing information generated by the controller 110, and data necessary for generating this information.

The display 140 is a display device including a Liquid Crystal Display (LCD), a backlight, and the like. The display 140 displays, under the control of the controller 110, data that is, for example, output by the controller 110.

The communicator 150 includes a communication interface to connect the selling apparatus 100 with the network 400.

The operating hardware 160 includes an input device, such as a button, a touch panel, and a keyboard. The operating hardware 160 receives an input operation from the user, and outputs, to the controller 110, an input-operation signal that corresponds to the received input operation.

Next, a functional configuration of the selling apparatus 100 will be described.

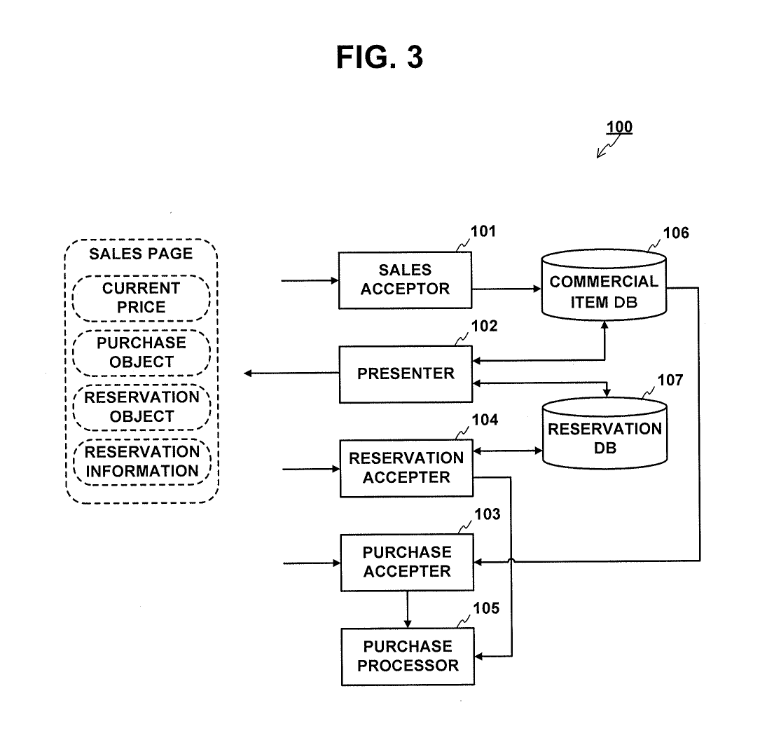

FIG. 3 is a schematic block diagram illustrating a functional configuration of the selling apparatus 100. As shown in FIG. 3, the selling apparatus 100 includes a sales acceptor 101, a presenter 102, a purchase acceptor 103, a reservation acceptor 104, and a purchase processor 105.

The sales acceptor 101 accepts information on a commercial item that will be on sale. More specifically, the sales acceptor 101 accepts, from the seller terminal 200, information on the commercial item that will be on sale, and registers this information in a commercial item database (DB) 106. The pieces of commercial item information accepted by the sales acceptor 101 are, for example, a commercial item name, a starting date and hour of the sale, a sales period, a sales price at the beginning of the sale, a sales price at the end of the sale, the maximum value of the number of price reductions (the maximum number of price reductions).

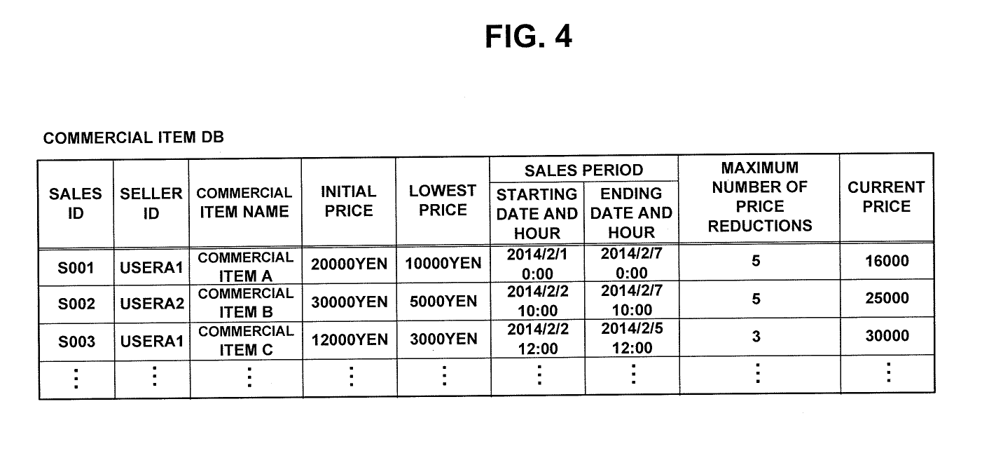

FIG. 4 illustrates example data stored in the commercial item DB 106. The commercial item DB 106 shown in FIG. 4 stores, for each sales business, a sales ID, a user ID of the seller (a seller ID), a commercial item name, an initial price, the lowest price, a starting date and hour of the sale, an ending date and hour thereof, the maximum number of price reductions, and a current price. The commercial item DB 106 may be stored in the ROM 120 or may be stored in an external memory device.

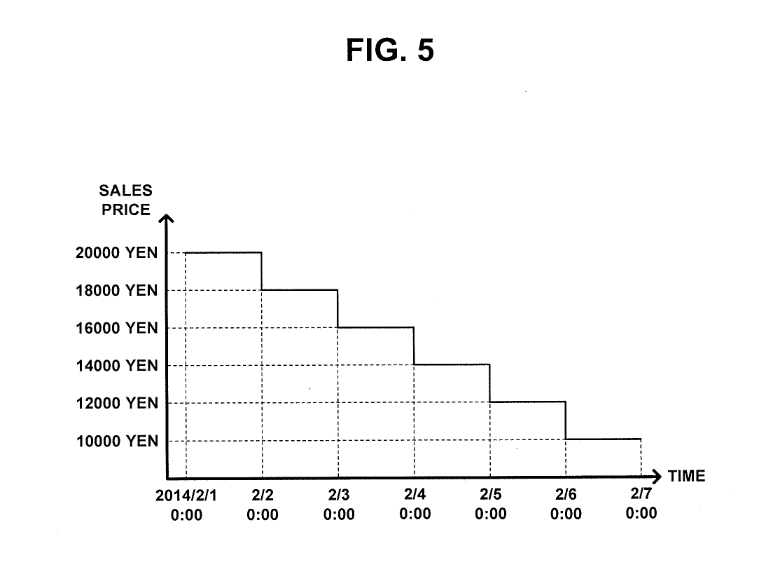

Next, a change in the sales price of the commercial item according to this embodiment over time will be described with reference to data on a commercial item A that is recorded in the commercial item DB 106 as shown in FIG. 4. FIG. 5 illustrates an example change in the sales price of the commercial item A over time. As is shown in FIG. 5, the sales price of the commercial item A is “20000 YEN” at the starting date and hour of the sale that is “2014 Feb. 1 0:00”. Subsequently, if no purchaser is settled, the sales price of the commercial item A is decreased by 2000 YEN per a day, and the sales price reaches the lowest price that is “10000 YEN” at “2014 Feb. 6 0:00” that is one day before the ending date and hour of the sale which is “2014 Feb. 7 0:00”. In addition, if no purchaser is settled at the ending date and hour of the sale that is “2014 Feb. 7 0:00”, the sales of the commercial item A ends.

As discussed above, the sales price of the commercial item A is calculated based on a period (a unit sales period) from the starting date and hour or from the date and hour of the previous price reduction to the date and hour at which the subsequent price reduction is carried out that is one day, and based on an amount of price reduction for each time (a unit price reduction amount) that is 2000 YEN, but the unit sales period and the unit price reduction amount are calculated based on the data of the commercial item A recorded in the commercial item DB 106. More specifically, the sales acceptor 101 calculates the unit sales period based on the starting date and hour of the sale and the ending date and hour thereof, and the maximum number of price reductions so as to equalize the sales periods before and after the price reduction. In addition, the sales acceptor 101 calculates the unit price reduction amount based on the initial price, the lowest price, and the maximum number of price reductions so as to equalize the price reduction amount for each step.

In this embodiment, the controller 110 in cooperation with the communicator 150 serves as the sales acceptor 101.

The presenter 102 generates and presents a sales page based on data stored in the commercial item DB 106 and data stored in reservation DB 107 which will be discussed later. In addition, the presenter 102 updates the current price in the commercial item DB 106 by reducing the current price of the commercial item by the unit price reduction amount for each unit sales period.

Note that the sales page is a page presented on the purchaser terminal 300, and is also a page containing information on the commercial item on sale. More specifically, the presenter 102 presents the sales page having disposed therein a purchase object for accepting a purchase operation of the commercial item, a reservation object for accepting a reservation operation of the commercial item, and reservation information indicating whether or not a reservation has been accepted.

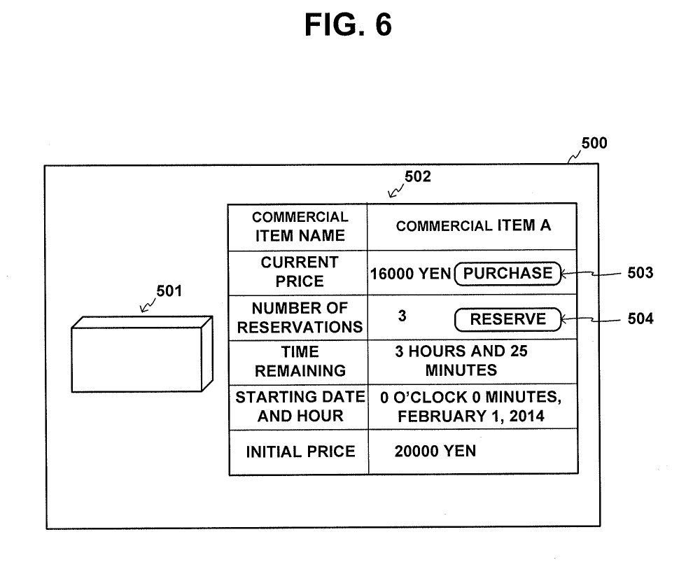

FIG. 6 illustrates an example sales page 500 presented by the presenter 102. The sales page 500 shown in FIG. 6 is an example sales page for the commercial item A in the commercial item DB 106 in FIG. 4. The sales page 500 has disposed therein an image 501 of the commercial item A, detail information 502 on the commercial item A, a purchase object 503, and a reservation object 504.

The detail information 502 contains a commercial item name of the commercial item A, a current price, the number of reservations, a time remaining, a starting date and hour, and an initial price. The commercial item name of the commercial item A, the current price, the starting date and hour, and the initial price are obtained from the commercial item DB 106. The remaining time is obtained based on the current time, the starting date and hour, and the unit sales period for the commercial item A. In addition, the number of reservations is obtained from the number of reservations for the commercial item A recorded in the reservation DB 107 which will be discussed later.

The purchase object 503 and the reservation object 504 are selectable buttons. By having the purchase object 503 selected by a user of the purchaser terminal 300, the commercial item A is purchased by the user. Similarly, by having the reservation object 504 selected by the user of the purchaser terminal 300, the user can make a purchase reservation for the commercial item A.

In this embodiment, the controller 110 and the communicator 150 serve as the presenter 102.

When the purchase object 503 disposed on the sales page 500 is selected, the purchase acceptor 103 accepts a purchase at the current price that is presented on the sales page 500.

For example, when receiving from the purchaser terminal 300 input information indicating that the purchase object 503 has been selected by the user, the purchase acceptor 103 settles this user as a purchaser at the current price presented on the sales page.

In this embodiment, the controller 110 in cooperation with the communicator 150 serves as the purchase acceptor 103.

When the reservation object 504 disposed on the sales page 500 is selected, the reservation acceptor 104 accepts a purchase reservation at a non-public reserve price that is lower than the current price presented on the sales page 500. In addition, if a reservation at a price equal to or higher than the sales price that will be set after the next price reduction is accepted at a time point at which the unit sales period has elapsed, the reservation acceptor 104 settles the user who has made a reservation as a purchaser at the reserve price.

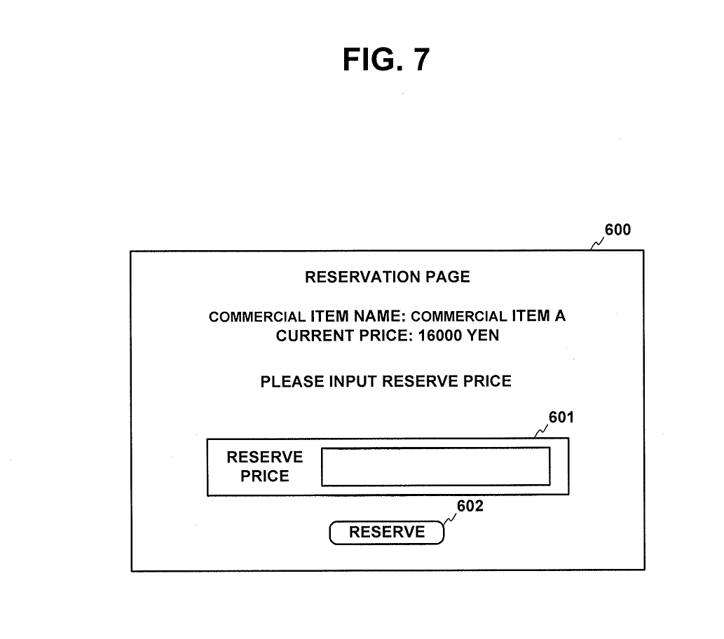

For example, when accepting, from the purchaser terminal 300, input information indicating that the reservation object 504 is selected by the user, the reservation acceptor 104 presents a reservation page 600 on the purchaser terminal 300. FIG. 7 illustrates an example reservation page 600. As is shown in FIG. 7, an input form 601 for accepting an input operation of the reserve price, and a reserve confirmation object 602 for accepting a reservation at the reserve price that is input on the input form 601 are disposed on the reservation page 600. When the user of the purchaser terminal 300 inputs, on the input form 601, the reserve price that is lower than the current price, and selects the reserve confirmation object 602, the reservation acceptor 104 accepts a purchase reservation of the commercial item A at the reserve price that has been input by the user. Upon accepting the reservation, the reservation acceptor 104 records, in the reservation DB 107, an ID of the user who has made the reservation and the accepted reserve price in association with a sales ID.

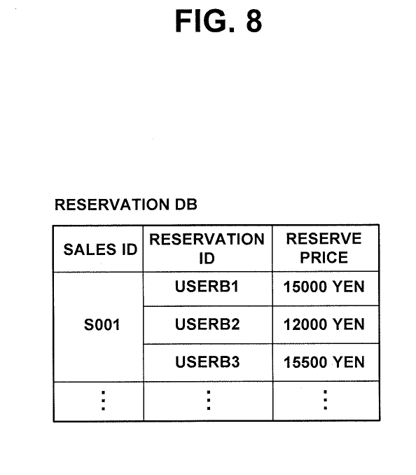

FIG. 8 illustrates example data stored in the reservation DB 107. The reservation DB 107 in FIG. 8 stores, for each sales business, the sales ID, the user ID (reservation ID) of the user who has made the reservation, and the reserve price. The reservation DB 107 may be stored in the ROM 120 or may be stored in an external memory device.

In this embodiment, the controller 110 in cooperation with the communicator 150 serves as the reservation acceptor 104.

The purchase processor 105 initiates a purchase process for the purchaser who is settled by the purchase acceptor 103 or by the reservation acceptor 104.

For example, when the purchase acceptor 103 settles the purchaser, the purchase processor 105 initiates the purchase process for the user's purchase at the presented current price. Similarly, when the reservation acceptor 104 settles the purchaser, the purchase processor 105 initiates the purchase process for the user's purchase at the reserve price.

In this embodiment, the controller 110 in cooperation with the communicator 150 serves as the purchase processor 105.

Next, operation of the selling apparatus 100 according to this embodiment will be described.

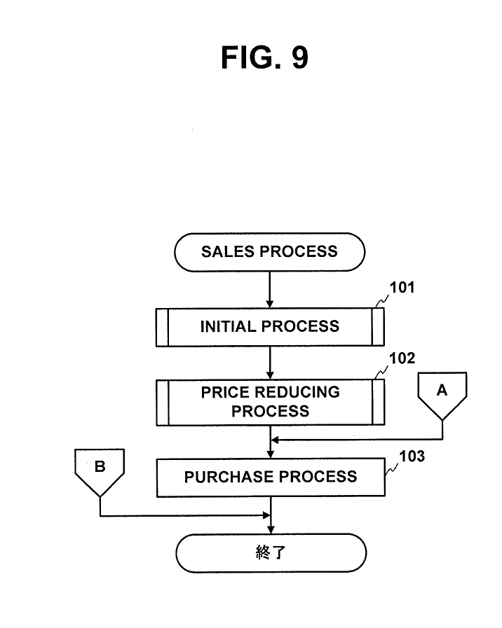

The purchase process executed by the selling apparatus 100 will now be described. FIG. 9 is an example flowchart of the sales process. The sales process in FIG. 9 is initiated, for example, when the starting date and hour of the sale for each commercial item recorded in the commercial item DB has reached the current time. In the following discussion, it is assumed that the information (data corresponding to the sales ID “S001”) on the commercial item A has been already registered in the commercial item DB 106 from the seller terminal 200 as shown in FIG. 4, and the starting date and hour of the sale for the commercial item A recorded in the commercial item DB 106 has reached the current time. Note that this process is executed by, for example, the CPU of the controller 110 that reads a program stored in the ROM 120.

Firstly, the selling apparatus 100 executes an initial process (step S101).

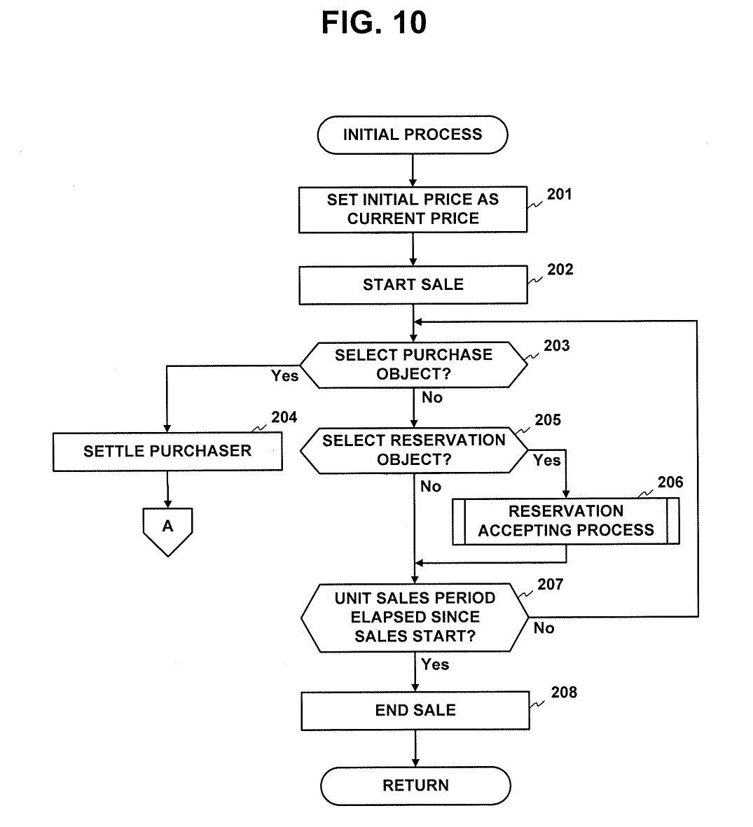

FIG. 10 illustrates an example flowchart of the initial process. As is shown in FIG. 10, when the initial process is initiated, the presenter 102 sets an initial price that is “20000 YEN” as a current price for the commercial item A in the commercial item DB 106 (step S201).

Next, the selling apparatus 100 starts the sale of the commercial item A (step S202).

More specifically, when receiving, from the purchaser terminal 300, requests for the sales page 500 of the commercial item A, the presenter 102 checks the commercial item DB 106 and obtains detail information 502 that contains the name of the commercial item A, the current price, the time remaining, the starting date and hour, and the initial price. In addition, the presenter 102 checks the reservation DB 107 and obtains detail information 502 that contains the number of reservations which are associated with the sales ID “S001”. Thereafter, the presenter 102 generates the sales page 500 containing the obtained detail information 502, the purchase object 503, and the reservation object 504, and presents this sales page on the purchaser terminal 300.

The purchase acceptor 103 determines whether or not the purchase object is selected through the purchaser terminal 300 (step S203).

When determining that the purchase object 503 is selected through the purchaser terminal 300 (step S203; Yes), the purchase acceptor 103 settles the user of this purchase terminal 300 as the purchaser (step S204). Thereafter, the process proceeds to step S103 in FIG. 9.

That is, when the purchase object 503 is selected in the step S203 through the purchaser terminal 300, the purchase of the commercial item A by the user of this purchaser terminal 300 is accepted at the current price that is “20000 YEN”.

When determining that no purchase object 503 is selected through the purchaser terminal 300 (step S203; No), the reservation acceptor 104 determines whether or not the reservation object 504 is selected through the purchaser terminal 300 (step S205).

When the reservation acceptor 104 determines that no reservation object 504 is selected through the purchaser terminal 300 (step S205; No), the process proceeds to step S207. In addition, when determining that the reservation object 504 is selected through the purchaser terminal 300 (step S205; Yes), the reservation acceptor 104 executes a reservation accepting process (step S206).

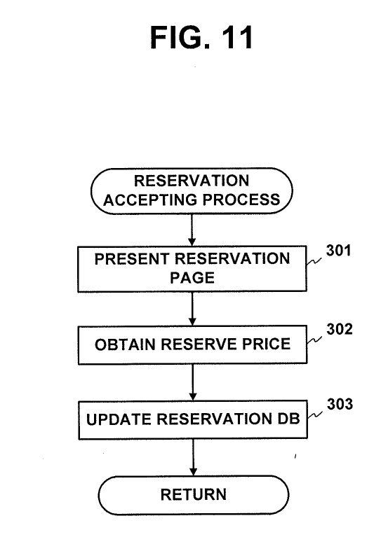

FIG. 11 illustrates an example flowchart of the reservation accepting process. As shown in FIG. 11, when the reservation accepting process is initiated, the reservation acceptor 104 presents, on the purchaser terminal 300 that has selected the reservation object 504, the reservation page 600 shown in FIG. 7 (step S301).

Next, the reservation acceptor 104 obtains the reserve price from the input form 601 contained in the reservation page 600 (step S302).

Subsequently, the reservation acceptor 104 updates the reservation DB 107 (step S303). More specifically, the reservation acceptor 104 records, in the reservation DB 107, the user ID (reservation ID) of the user whose reservation is accepted and the reserve price in association with the sales ID “S001”.

Next, returning to the flowchart of FIG. 10, the selling apparatus 100 determines whether or not the unit sales period has elapsed since the starting time and hour (step S207). When determining that the unit sales period has not elapsed since the starting date and hour (step S207; No), the selling apparatus 100 returns the process to the step S203, and continues the sales of the commercial item A. Conversely, when determining that the unit sales period has elapsed since the starting date and hour (step S207; Yes), the selling apparatus 100 ends the sales of the commercial item A at the current sales price that is, the current price of “20000 YEN” (step S208).

Next, returning to the flowchart of FIG. 9, the selling apparatus 100 executes a price reducing process (step S102).

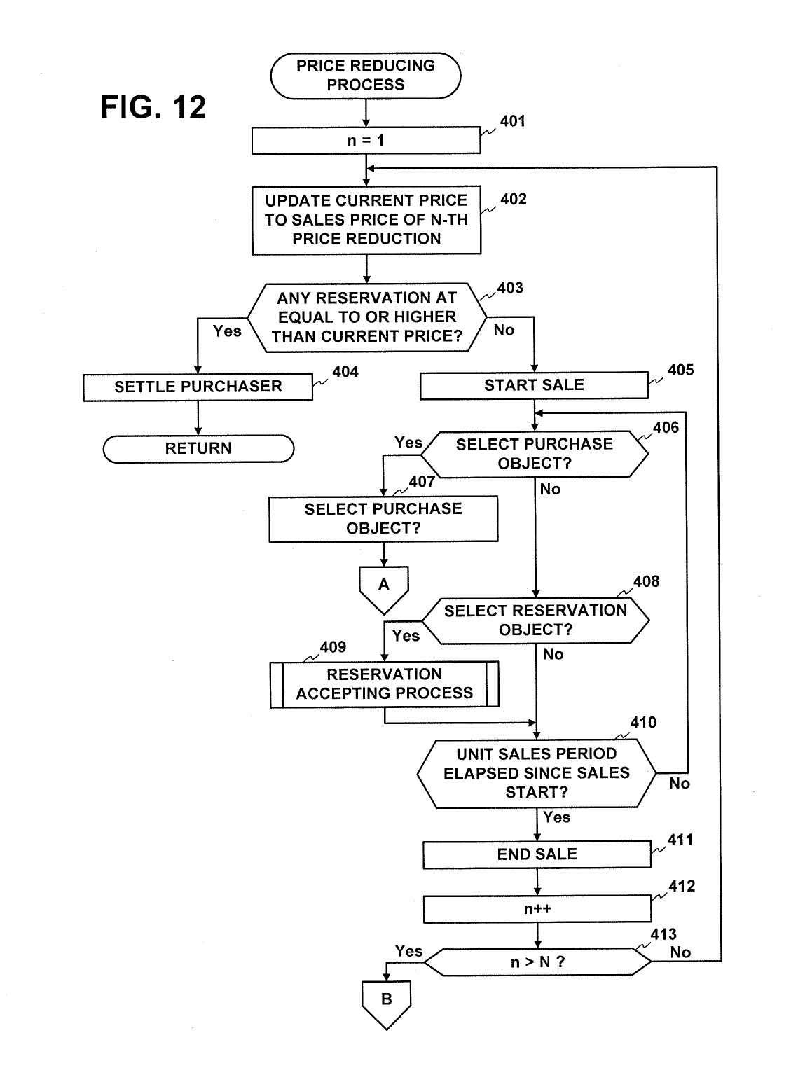

FIG. 12 shows an example flowchart of the price reducing process. As shown in FIG. 12, when the price reducing process is initiated, the presenter 102 substitutes an initial value that is 1 in the number of price reductions n (step S401).

Next, the presenter 102 calculates the sales price at the n-th price reductions and updates the current price in the commercial item DB 106 to the calculated current price (step S402).

More specifically, the presenter 102 calculates the sales price at the time of the n-th price reduction by multiplying the unit price reduction amount by n, and subtracting the multiplied unit price reduction amount from the initial price. When, for example, the present price reduction is the first-time price reduction, the presenter 102 records, in the commercial item DB 106, the current price of “18000 YEN” for the commercial item A obtained by subtracting the unit price reduction amount of 2000 YEN from the initial sales price that is “20000 YEN”.

Next, the reservation acceptor 104 compares the current price of the commercial item A with the reserve price of the commercial item A stored in the reservation DB 107, and determines whether or not there is the reserve price that is equal to or higher than the current price (step S403).

When determining that there is the reserve price that is equal to or higher than the current price (step S403; Yes), the user who has input the reserve price with the user ID is settled as the purchaser (step S404). Thereafter, the process proceeds to the step S103 in FIG. 9.

Note that when there is a plurality of users making input of reserve prices that are equal to or higher than the current price, the user with the highest input reserve price among these users can be settled as the purchaser of the commercial item. Furthermore, when the highest reserve price is input by a plurality of users, the purchaser of the commercial item may be settled at random among those users.

When, for example, the present price reduction is the third-time price reduction, the current price is updated to “14000 YEN” in the step S402. This current price is compared with the reserve price corresponding to the sales ID “S001” that is recorded in the reservation DB 107 shown in FIG. 8. Two reserve prices, the reserve price “15000 YEN” with a reservation ID “USERB1” and the reserve price “15500 YEN” with a reservation ID “USERB3” are reserve prices that are equal to or higher than the current price. Accordingly, the reservation acceptor 104 settles the purchaser of the commercial item A to the user with the reservation ID “USERB3” who has made reservation at the higher reserve price between the two reserve prices.

When the reservation accepter 104 determines that there is no reserve price that is equal to or higher than the current price (step S403; No), the selling apparatus 100 executes processes in steps S405 to S411 likewise the initial process in the steps S202 to S208 shown in FIG. 10. That is, the selling apparatus 100 sells the commercial item A at the current price that is the sales price having undergone the n-th price reduction.

When the sale of the commercial item ends in the step S411, the presenter 102 increments the number n of price reductions (step S412), and determines whether or not this number n of price reductions is greater than the maximum number N of price reductions (step S413).

When the presenter 102 determines that the number n of price reductions is not greater than the maximum number N of price reductions (step S413; No), the process returns to the step S402.

Conversely, when the presenter 102 determines that the number n of price reductions is greater than the maximum number N of price reductions (step S413; Yes), the selling apparatus 100 ends the sales process.

Returning to the flowchart of FIG. 9, the purchase processor 105 executes the commercial item A's purchase process for the purchaser settled in the step S101 or in the step S102. More specifically, the purchase processor 105 obtains, from the user settled as the commercial item A's purchaser, information necessary to purchase the commercial item, such as the name and address of the user, a payment method for the commercial item, and shipping options of the commercial item, to execute the purchase procedure of the commercial item A. Thereafter, the selling apparatus 100 ends the sales process.

As discussed above, when selling the commercial item having the sales price decreasing over time, the selling apparatus 100 of this embodiment accepts the purchase reservation at the non-public reserve price that is lower than the current sales price, and presents the reservation status. Hence, by presenting the reservation status, users hesitating to purchase the commercial item can be encouraged to purchase the commercial item, and the commercial item can be sold at a high price in the earlier stage.

In addition, due to the non-public status of the reserve price, the users hesitating to purchase the commercial item are unable to know what prices and when other users desire to purchase the commercial item. Thus, it is capable of further increasing buying motivation of the users hesitating to purchase the commercial item.

### Second Embodiment

In the first embodiment described above, the time period of reducing the sales price of a commercial item is given based on the unit sales period and is set as a constant value for each sales business. However, the time period of reducing the sales price of the commercial item may be a different value for each user who has made a reservation for this commercial item. In a second embodiment, an example case will be discussed in which the time period of reducing the sales price of the commercial item is set for each user who has made a reservation for the commercial item.

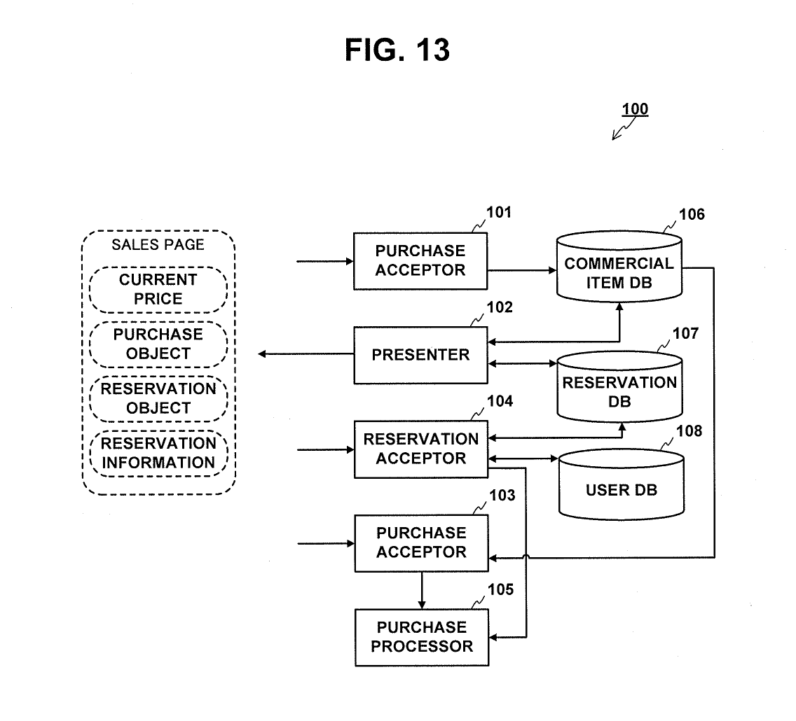

FIG. 13 is a schematic block diagram illustrating a functional configuration of the selling apparatus 100 according to the second embodiment. In the second embodiment, when accepting a reservation like the first embodiment, the reservation acceptor 104 checks a user DB 108 and obtains a rank of the user who has made a reservation.

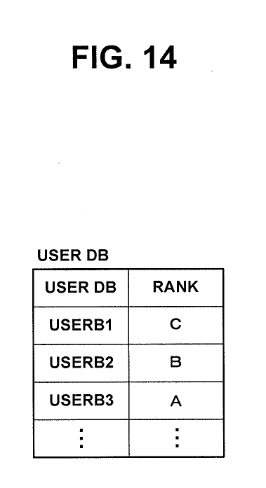

FIG. 14 illustrates example data stored in the user DB 108. The user DB 108 shown in FIG. 14 stores, for each user, the user ID and the user's rank in association with each other. Note that the user's rank represents a ranking of the users when they are ranked with reference to a predetermined index. The predetermined barometer is, for example, the user's credibility rating in the selling system 1. When, for example, a user X fails to complete the purchase of the commercial item A even though the user X has made a reservation for the commercial item A and has been settled as the purchaser of the commercial item A, the user X is regarded as a not-credible user so that the credibility rating is lowered. In the user DB 108 shown in FIG. 14, the users “USERB1”, “USERB2”, and “USERB3” are associated with a descending order rank of “A”, “B”, or “C”. The user DB 108 may be store in the ROM 120 or may be stored in an external memory device.

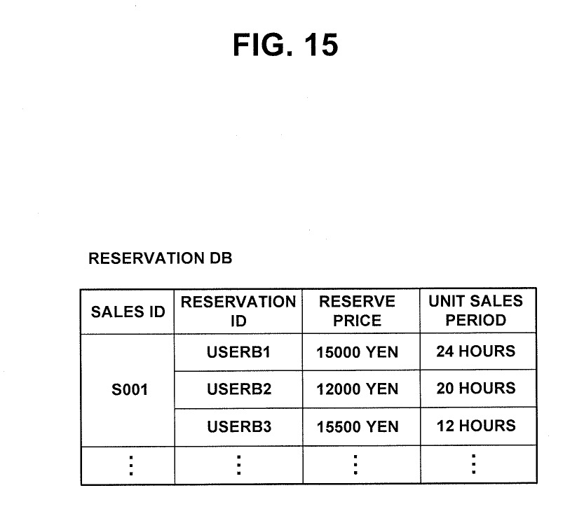

When obtaining the rank of the user who has made the reservation from the user DB 108, the reservation acceptor 104 sets the unit sales period based on the obtained user's rank. More specifically, the reservation acceptor 104 sets each unit sales period in such a way that, the higher the rank is, the shorter the unit sales period becomes. The reservation acceptor 104 allocates, for example, “12 hours”, “20 hours”, and “24 hours” as the unit sales periods to the ranks “A”, “B”, and “C”, respectively. Next, as shown in FIG. 15, the reservation acceptor 104 stores, in the reservation DB 107, the set unit sales period along with the user ID (reservation ID) of the user who has made the reservation and the reserve price in association with the sales ID.

In addition, in the sales process of the second embodiment, the reservation acceptor 104 determines whether or not the unit sales period has elapsed for each user who has made a reservation, and further determines whether or not any reservation made by that user at the price that is equal to or higher than the sales price after the next price reduction is carried out has been accepted. When determining that the reservation made by the user at the price that is equal to or higher than the sales price after the next price reduction is carried out has been accepted, this user who has made the reservation is settled as the purchaser at this reserve price.

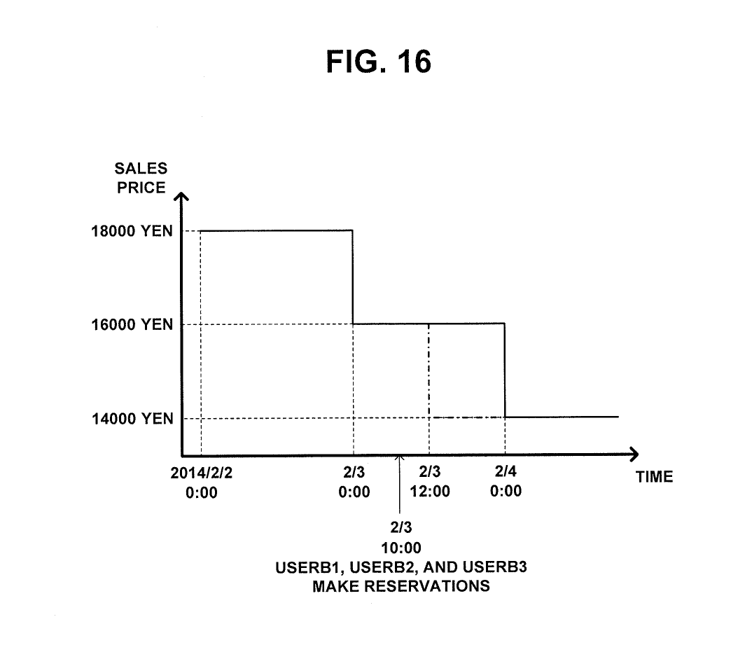

Next, a method for settling a purchaser among the users who have made reservations in the selling apparatus 100 of the second embodiment will be described in detail with reference to a change in the sales price of the commercial item A over time as shown in FIG. 16. As shown in FIG. 16, it is assumed that the second-time price reduction is carried out on the sales price of the commercial item A at a date and hour “2012 Feb. 3 0:00”, and the current price is changed to “16000 YEN”. It is also assumed that at a date and hour “2012 Feb. 3 10:00”, the users “USERB1”, “USERB2”, and “USERB3” have respectively made reservations at the reserve prices “15000 YEN”, “12000 YEN”, and “15500 YEN” as shown in FIG. 15. In this case, as shown in FIG. 15, the unit sales period for “USERB1” is “24 hours”, and thus the reservation acceptor 104 does not settle this user as the purchaser until the current time reaches a date and hour “2012 Feb. 4 0:00”. As for “USERB2”, the unit sales period for this user is “20 hours” as shown in FIG. 15, but since the sales price after the price reduction carried out when the current time reaches a date and hour “2012 Feb. 4 20:00” is “14000 YEN”, and thus this user is not settled as the purchaser. As for “USERB3”, the unit sales period for this user is “12 hours” as shown in FIG. 15, and the sales price after the price reduction carried out when the current time reaches a date and hour “2012 Feb. 3 12:00” is “14000 YEN”. Therefore, the reservation acceptor 104 settles “USERB3” as the purchaser.

As discussed above, the selling apparatus 100 according to the second embodiment is capable of varying ease of purchasing per individual user by setting the unit sales period for individual user. In addition, the buying motivation of high-ranking users can be increased by setting the unit sales period that becomes shorter as the user's rank gets higher.

### Third Embodiment

In the first embodiment described above, the sales price reduction for the commercial item is defined by the unit price reduction amount, and is set as a constant value for each sales business. However, the sales price reduction for the commercial item may be a different value for each user who has made the reservation for that commercial item. In a third embodiment, an example case will be discussed in which the sales price reduction of the commercial item is set for each user who has made a reservation for that commercial item.

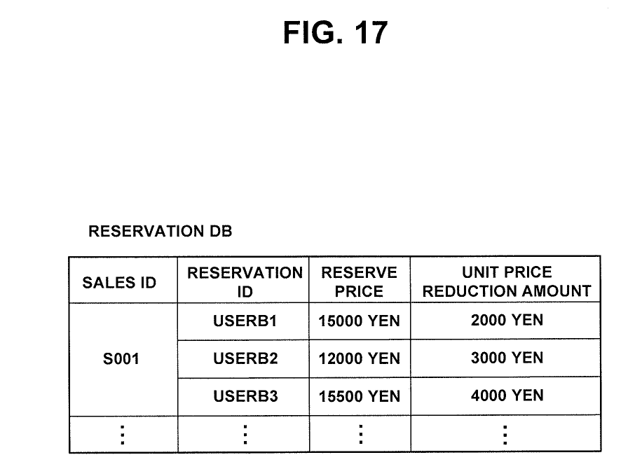

In the third embodiment, when obtaining, from the same user DB 108 in the second embodiment, the rank of the user who has made a reservation, the reservation acceptor 104 sets the unit price reduction amount based on the obtained user's rank. More specifically, the reservation acceptor 104 sets the unit price reduction amount in such a way that the higher the rank is, the larger the unit price reduction amount becomes. For example, the reservation acceptor 104 allocates “2000 YEN”, “3000 YEN”, and “4000 YEN” as the unit price reduction amounts based on a rank of “A”, “B”, or “C”. Next, as shown in FIG. 17, the reservation acceptor 104 stores, in the reservation DB 107, the set unit price reduction amount along with the user ID (reservation ID) of the user who has made a reservation and the reserve price in association with the sales ID.

Furthermore, upon calculating the sales price at the time of the price reduction in the sales process of the third embodiment, the reservation acceptor 104 calculates, for each user who has made a reservation, the sales price after the next price reduction carried out based on the unit price reduction amount that corresponds to the user. Next, the reservation acceptor 104 determines, for each user who has made a reservation, whether or not a reservation at the sales price that is equal to or higher than the sales price after the next price reduction is carried out that corresponds to this user has been accepted. When determining that a reservation at the sales price that is equal to or higher than the sales price after the next price reduction is carried out has been accepted, the user who has made the reservation is settled as the purchaser at this reserve price.

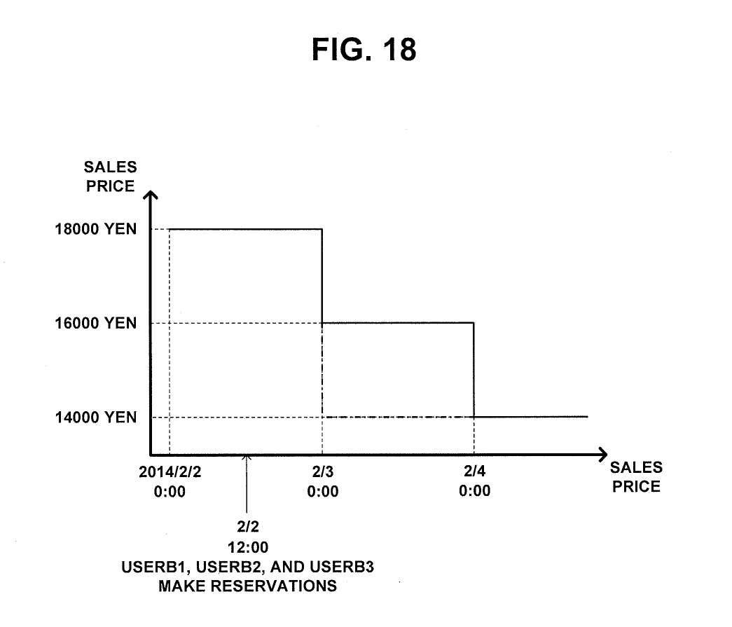

Next, a method for settling a purchaser among the users who have made reservations in the selling apparatus 100 of the third embodiment will be described in detail with reference to a change in sales price of the commercial item A over time as shown in FIG. 18. As shown in FIG. 18, it is assumed that the first-time price reduction is carried out on the sales price of the commercial item A at a time and hour “2012 Feb. 2 0:00”, and the current price is changed to “18000 YEN”. It is also assumed that at a time and hour 2012 Feb. 2 12:00, the users “USERB1”, “USERB2”, and “USERB3” have respectively made reservations at the reserve prices “15000 YEN”, “12000 YEN”, and “15500 YEN” as shown in FIG. 17. In this case, the users “USERB1” and “USERB2” respectively have the unit price reduction amounts of “2000 YEN” and “3000 YEN” as shown in FIG. 17, and the sales price after the price reduction is carried out at the current time “2012 Feb. 3 0:00” is “16000 YEN”. Hence, the reservation acceptor 104 settles no purchaser at this time point. Conversely, “USERB3” has the unit price reduction amount of “4000 YEN” as shown in FIG. 17, and the sales price after the price reduction carried out at the current time “2012 Feb. 3 0:00” is “14000 YEN”. Thus, the reservation acceptor 104 settles “USERB3” as the purchaser.

As discussed above, the selling apparatus 100 according to the third embodiment is capable of varying ease of purchasing per user by setting the unit price reduction amount for individual user. In addition, the buying motivation of high-ranking users can be increased by setting the unit price reduction amount that becomes larger as the user's rank gets higher.

The embodiments of the present disclosure were described above, but the present disclosure is not limited to those embodiments. Next, a modified example of the embodiments will be described. Note that in the modified example to be discussed below, the same structures as those of the aforementioned embodiments will be denoted by the same reference numerals, and the duplicated discussion thereof will be omitted.

In the aforementioned embodiments, the reservation acceptor 104 accepts inputting of the reserve price from the user who is making a reservation, but instead of the reserve price, the reservation acceptor 104 may accept inputting of a non-public time period to purchase the commercial item. Furthermore, the reservation acceptor 104 may calculate, based on the unit sales period and the unit price reduction amount, the sales price in the time period input by the user, obtain this sales price as the reserve price, and store this sales price in the reservation DB 107. In addition, the reservation acceptor 104 may accept, from the user who is making a reservation, a purchase designation at the next price reduction.

Still further, in the aforementioned embodiments, the presenter 102 refers to the reservation DB 107 and disposes the number of reservations on the sales page 500 of the commercial item, but the reservation information disposed on the sales page 500 is not limited to the number of reservations. The presenter 102 may, for example, refer to the reservation DB 107 and dispose the status indicating the presence/absence of a reservation on the sales page 500 of the commercial item.

Note that in the aforementioned embodiments, the program to be run by the selling apparatus 100 may be stored in and distributed together with a computer readable non-transitory recording medium, such as a flexible disk, a CD-ROM (Compact Disk Read-Only Memory), a DVD (Digital Versatile Disk), and a MO (Magneto-Optical Disk). In addition, the selling apparatus 100 that executes the aforementioned processes may be configured by having the program installed on an information processing apparatus like a personal computer.

Alternatively, the program may be stored in a disk device or the like of a predetermined server apparatus over a communication network like the Internet. In addition, the program may be, for example, superimposed on a carrier wave and downloaded.

Furthermore, when the aforementioned functions are accomplished by an Operating System (OS) that shares such functions, or by cooperative action of the OS with an application, only the program other than the portions accomplishing the OS function may be stored in a non-transitory recording medium, and distributed or downloaded.

Modifications and variations can be made without departing from broader spirit and scope of the present disclosure. It should be noted that the above embodiments are meant only to be illustrative of those embodiments and are not intended to be limiting the scope of the present disclosure. Accordingly, the scope of the present disclosure should not be determined by the embodiments illustrated, but by the appended claims. It is therefore the intention that the present disclosure be interpreted to include various modifications that are made within the scope of the claims and their equivalents.

### INDUSTRIAL APPLICABILITY

The present disclosure is suitable for electronic commercial transactions through a network like the Internet.

### REFERENCE SIGNS LIST

1 Selling system
100 Selling apparatus
101 Sales acceptor
102 Presenter
103 Purchase accepter
104 Reservation acceptor
105 Purchase processor
106 Commercial item DB
107 Reservation DB
108 User DB
110 Controller
120 ROM
130 RAM
140 Display
150 Communicator
160 Operating hardware
170 Bus
200 Seller terminal
300 Purchaser terminal
400 Network
500 Sales page
501 Image
502 Detail information
503 Purchase object
504 Reservation object
600 Reservation page
601 Input form
602 Reserve confirmation object

1. A selling apparatus comprising:
a presenter that presents a sales page having disposed therein a current sales price of a commercial item having a sales price decreasing over time, a purchase object, and a reservation object;
a purchase acceptor that accepts a purchase at the disposed sales price of the commercial item when the disposed purchase object is selected; and
a reservation acceptor that accepts a purchase reservation at a non-public reserve price that is lower than the disposed sales price of the commercial item when the disposed reservation object is selected,
wherein a reduction level of the sales price or a time period for price reduction is defined for each user who makes the reservation based on a ranking of the user who makes the reservation.

2. The selling apparatus according to claim 10, wherein the reservation information includes the number of the accepted reservations.

3. The selling apparatus according to claim 1, wherein in the reservation, the non-public reserve price is specified by specifying a non-public time period for purchasing the commercial item.

4. The selling apparatus according to claim 1, wherein when the reservation acceptor accepts a plurality of reservations at a same reserve price, and the sales price of the commercial item reaches the same reserve price, one of the plurality of reservations is selected, and a purchase process for a user who has made the selected reservation is executed.

5. (canceled)

6. The selling apparatus according to claim 1, wherein the higher the ranking of the user who makes the reservation is, the higher the reduction level of the sales price is or the shorter the time period for price reduction is.

7. A selling method to be executed by a selling apparatus that includes a presenter, a purchase acceptor, and a reservation acceptor, the method comprising:
a presenting step of causing the presenter to present a sales page having disposed therein a current sales price of a commercial item having a sales price decreasing over time, a purchase object, and a reservation object;
a purchase accepting step of causing the purchase acceptor to accept a purchase at the disposed sales price of the commercial item when the disposed purchase object is selected; and
a reservation accepting step of causing the reservation acceptor to accept a purchase reservation at a non-public reserve price that is lower than the disposed sales price of the commercial item when the disposed reservation object is selected,
wherein a reduction level of the sales price or a time period for price reduction is defined for each user who makes the reservation based on a ranking of the user who makes the reservation.

8. (canceled)

9. A computer-readable non-transitory recording medium having stored therein a program that causes a computer to function as:
a presenter that presents a sales page having disposed therein a current sales price of a commercial item having a sales price decreasing over time, a purchase object, and a reservation object;
a purchase acceptor that accepts a purchase at the disposed sales price of the commercial item when the disposed purchase object is selected; and
a reservation acceptor that accepts a purchase reservation at a non-public reserve price that is lower than the disposed sales price of the commercial item when the disposed reservation object is selected,
wherein a reduction level of the sales price or a time period for price reduction is defined for each user who makes the reservation based on a ranking of the user who makes the reservation.

10. The selling apparatus according to claim 1, wherein the presenter further disposes, in the sales page, reservation information indicating a presence or absence of an accepted reservation.

11. The selling method according to claim 7, wherein in the presenting step, the presenter further disposes, in the sales page, reservation information indicating a presence or absence of an accepted reservation.

12. The selling method according to claim 11, wherein the reservation information includes the number of the accepted reservations.

13. The selling method according to claim 7, wherein in the reservation, the non-public reserve price is specified by specifying a non-public time period for purchasing the commercial item.

14. The selling method according to claim 7, wherein in the reservation accepting step, when the reservation acceptor accepts a plurality of reservations at a same reserve price, and the sales price of the commercial item reaches the same reserve price, one of the plurality of reservations is selected, and a purchase process for a user who has made the selected reservation is executed.

15. The selling method according to claim 7, wherein the higher the ranking of the user who makes the reservation is, the higher the reduction level of the sales price is or the shorter the time period for price reduction is.

16. The computer-readable non-transitory recording medium according to claim 9, wherein the presenter further disposes, in the sales page, reservation information indicating a presence or absence of an accepted reservation.

17. The computer-readable non-transitory recording medium according to claim 16, wherein the reservation information includes the number of the accepted reservations.

18. The computer-readable non-transitory recording medium according to claim 9, wherein in the reservation, the non-public reserve price is specified by specifying a non-public time period for purchasing the commercial item.

19. The computer-readable non-transitory recording medium according to claim 9, wherein when the reservation acceptor accepts a plurality of reservations at a same reserve price, and the sales price of the commercial item reaches the same reserve price, one of the plurality of reservations is selected, and a purchase process for a user who has made the selected reservation is executed.

20. The computer-readable non-transitory recording medium according to claim 9, wherein the higher the ranking of the user who makes the reservation is, the higher the reduction level of the sales price is or the shorter the time period for price reduction is.
